(19) United States
(12) Patent Application Publication
(10) Pub. No.: US 2002/0170793 A1
(43) Pub. Date: Nov. 21, 2002

(54) Nonlinear mass damper with active centerband control

(76) Inventor: Zoltan A. Kemeny, Tempe, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/145,075

(22) Filed: May 14, 2002

Related U.S. Application Data
(60) Provisional application No. 60/291,157, filed on May 15, 2001.

(51) Int. Cl. F16F 7/10

(52) U.S. Cl. 188/378

(57) ABSTRACT

A mass damper (12) is attached to a machine tool (11) to suppress the vibration and oscillations induced by the machine tool. The mass damper uses a sensor (50) or transducer (70) to sense changes in vibration frequency or other physical action and control an actuator (56) to move a piston assembly (60). The piston assembly operates to increase or decrease compression on a spring (38) attached to a bob or moveable mass (18) within a housing (13) of the mass damper. The bob oscillates in opposite phase with the vibration induced by the machine tool to counteract the undesired vibration. The compression spring acts as a restoring force to bring the bob back to its neutral position. The change in compression on the restoring spring effectively changes the center frequency of the mass damper to keep the frequency response of the machine tool within the bandwidth of the mass damper.

### CLAIM TO DOMESTIC PRIORITY

The present non-provisional patent application claims priority to the provisional application serial No. 60/291,157, entitled “Nonlinear Mass Damper with Active Centerband Control”, filed on May 15, 2001, by Zoltan A. Kemeny.

### FIELD OF THE INVENTION

The present invention relates in general to mechanical vibration dampening and mass dampers and, more particularly, to a nonlinear mass damper having a broad frequency response and adjustable center frequency.

### BACKGROUND OF THE INVENTION

Many types of manufacturing equipment and tools exhibit or experience vibration and oscillations during operation. The vibrating and oscillating action is a natural side-effect of motor operation, rotating bearings and shafts, oscillating and reciprocating parts, impacting sources, and other apparatus undergoing physical movement. The vibration and oscillations induced by some manufacturing equipment can cause an undesirable and detrimental action either on the same equipment or on other equipment. This is especially true in environments that require very precise processing, e.g. masking, cutting, shaping, application and removal of material, and other manufacturing steps that involve precise operations and extremely small dimensions.

If, for example, a manufacturing step involves application of material or making a cut, and the manufacturing equipment is experiencing vibrations or oscillations, then result of the operation will likely be at least partially in error. The path or width of the cut, or the area where material was supposed to be applied, or the area where material was not supposed to be applied, will be off in relation to the nature, frequency, magnitude, and direction of the undesired vibration or oscillations. Any vibration in a precision machine tool often leads to defects and imperfections in the work piece and thereby reduces production yield.

The vibration problem exists as well in the manufacture of semiconductors because of the large number of motors, rotating shafts, and mechanical movement underway in the same environment with high precision machine tools and precise processing that must be accurately performed on extremely small dimensions. One of the semiconductor processes that is known to induce vibration is chemical mechanical polishing (CMP) which involves polishing a semiconductor wafer using a combination of chemical and mechanical tools. The mechanical portion uses a motor rotating a shaft which is attached to a polishing pad. A semiconductor wafer is brought in contact with the rotating polishing pad to planarize or smooth out the surface of the wafer. The chemical portion involves application of a slurry chemistry under the polishing pad to help dissolve or etch away surface materials. There are a number of different options to the CMP process depending on the type of semiconductor material and desired precision of the process. The CMP process may vary the rotating speed of the polishing pad, pressure of the polishing pad against the wafer, and rate of application and type of slurry.

The three-dimensional physical movement of the CMP operations are known to develop vibrations having high frequency or low frequency components. The nature, frequency, magnitude, and direction of the vibration is dependent on the speed, movement, and physical action of the CMP tool, which in turn is dependent upon the CMP process being performed. The vibration can be transmitted through the CMP support table or base, and through the factory floor, to other vibration sensitive machines and tools which are processing semiconductor wafers. Thus, the vibration can cause errors in the same or other manufacturing processes and defects to the semiconductor wafer.

One solution known in the prior art involves the use of a broad band, passive mass damper to suppress or cancel the vibration and oscillations. A broad band mass damper is disclosed in U.S. Pat. No. 6,364,077 entitled, “Conservative Broadband Passive Mass Damper.” The mass damper is a mechanical device which comprises a bob or moveable mass supported by springs and a plurality of ball-in-recess assemblies. A base of the mass damper is rigidly attached to a source of vibration, e.g. CMP tool or other manufacturing equipment. The vibration generated by the manufacturing equipment is transmitted to the mass damper and induces an opposite phase vibration or movement in the bob which suppresses or cancels the vibration source. The characteristics and bandwidth of the mass damper, e.g. mass of the bob, spring constant, and center frequency, are fixed to match the manufacturing process which is causing the vibration, e.g. rotation speed and downward force of the polishing pad and rate of application and type of slurry. To handle a broader range of vibrating frequencies sometimes a plurality of passive mass dampers are used each tuned to a particular frequency band.

Other prior art solutions have focused on active mass damping systems. An active mass damping system typically uses a feedback system to monitor the amplitude and frequency of the vibration and generate a cancellation or compensation motion to reduce or eliminate the vibration. The active mass damping system is often highly complex, prohibitively expensive, and a potential source of equipment downtime for repairs and maintenance.

### BRIEF DESCRIPTION OF THE DRAWINGS

FIG. 1 illustrates a mass damper with active centerband control;

FIG. 2 is a frequency response plot of the mass damper of FIG. 1; and

FIG. 3 illustrates an alternative embodiment for the gravity restoring support assembly.

### DETAILED DESCRIPTION OF THE DRAWINGS

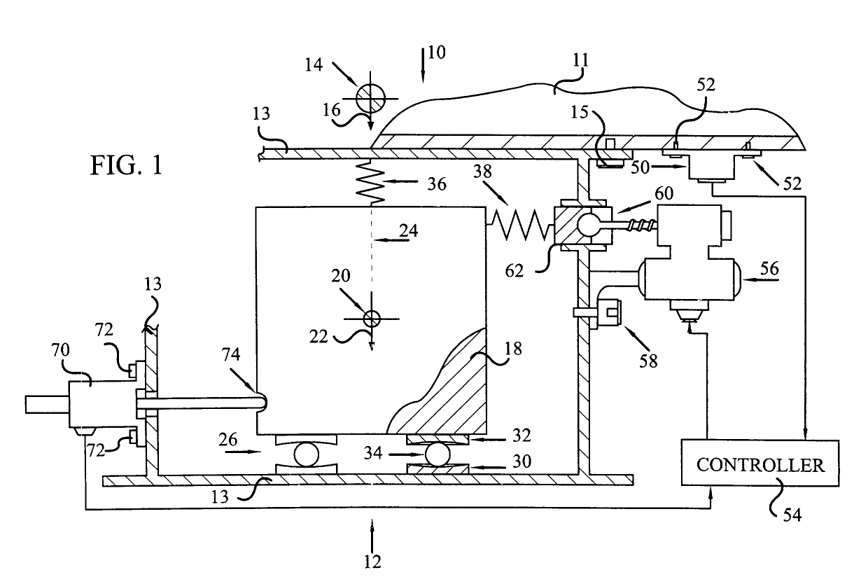

A mass damper system 10 is shown in FIG. 1. Machine tool 11 represents a portion of a unit of manufacturing equipment or tool which induces, exhibits, or otherwise experiences vibration, oscillations, or shaking during its operation. The vibrating and oscillating action is a common side-effect of motor operation, rotating bearings and shafts, oscillating and reciprocating parts, impacting sources, and other apparatus undergoing physical motion. Machine tool 11 represents equipment that can be found in virtually any manufacturing environment. For example, in the manufacture of semiconductors, machine tool 11 can be a CMP tool which is involved in the polishing a semiconductor wafer using a combination of chemical and mechanical tools. The mechanical portion uses a motor rotating a shaft which is attached to a polishing pad. A semiconductor wafer is brought in contact with the rotating polishing pad to planarize or smooth out the surface of the wafer. The chemical portion involves application of a slurry chemistry under the polishing pad to help dissolve or etch away surface materials. There are a number of different options to the CMP process depending on the type of semiconductor material and desired precision of the process. The CMP process may vary the rotating speed of the polishing pad, pressure of the polishing pad against the wafer, and rate of application and type of slurry.

The three-dimensional physical movement of the CMP tool is known to develop vibrations having high frequency or low frequency components. The nature, frequency, magnitude, and direction of the vibration is dependent on the speed and motion of the CMP tool, which in turn is dependent upon the CMP process being performed. The vibration can be transmitted through the CMP support table or base, and through the factory floor, to other vibration-sensitive, precision machines and tools.

The vibration and oscillations induced by machine tool 11 can cause an undesirable and detrimental action, especially in environments like the manufacture of semiconductors that involve precise operations and/or extremely small dimensions. Any vibration transmitted to a precision machine tool can lead to errors in the manufacturing process and defects and imperfections in the semiconductor wafer which reduces production yield.

In mass damper system 10, mass damper 12 is attached to machine tool 11 to counteract, suppress, reduce, cancel, and/or neutralize the vibration and oscillations induced by machine tool 11. Mass damper 12 counteracts the vibration of machine tool 11 though an action of passive mass resonance. A upper plate or member of housing 13 of mass damper 12 is attached or secured to a bottom base or plate of machine tool 11 (i.e. mounted below) with bolts 15. Alternatively, a lower plate or member of housing 13 is attached or secured to a upper base or plate of machine tool 11 (i.e. mounted above). Mass damper 12 can also be attached or secured to machine tool 11 with clamps, screws, weld, adhesive, and any other attachment mechanism which provides a firm connection. Housing 13 is made of aluminum or other durable material.

Machine tool 11 has a center of mass 14 and a mass magnitude 16. Mass damper 12 includes a bob or moveable mass 18 which is sufficiently large in comparison to the mass of machine tool 11. Bob 18 is made of steel, stainless, steel, or other material providing the desired mass for the application, and can be cubical, cylindrical, spherical, conical, or other shape or dimension(s) compatible with the support mechanism described below. Bob 18 has a center of mass 20 and a mass magnitude 22. Mass magnitude 22 is about 0.5-5.0 percent of mass magnitude 16.

Housing 13 encloses bob 18. Center of mass 20 is positioned proximate to and symmetrically about centerline 24 to align with center of mass 14. Bob 18 is moveably attached within housing 13 with compression springs 36 and 38 and bearings 26. Bob 18 is supported by bearings 26, which each comprise concave base plate 30, opposing cover plate 32, and intermediate ball 34. Bearings 26 provide a gravity restoring feature, i.e. they restore an onset lateral displacement by gravity alone. Base plates 30 are attached or secured to housing 13 and cover plates 32 are attached or secured to bob 18 with bolts, screws, weld, adhesive, and any other attachment mechanism which provides a firm connection.

Compression spring 36 is attached between a top surface of bob 18 and the upper plate or member of housing 13. Compression spring 36 operates as a gravity restoring force and support assembly. Compression spring 36 may be a single spring or comprise multiple springs. Compression spring 38 is attached between a side surface of bob 18 and piston assembly 60. Typically, four compression springs like 38 (not shown) are attached one to each side surface of bob 18. Other types of springs, such as coil springs, crest-to-crest springs, stack of belleville or disk springs, and pre-loaded mechanical springs, can be used as well to provide a restoring force to each side surface of bob 18. Compression springs 36 and 38 provide a restoring force to movement induced in bob 18 by the vibration and oscillations of machine tool 11. Compression springs 36 and 38 also provide auxiliary support and elastic retention of bob 18 within housing 13, and help prevent movement of bob 18 during transport. Compression springs 36 and 38 may have linear or nonlinear spring constants; however, the use of non-linear compression springs may provide a broader frequency response.

In other embodiments, bob 18 is supported on one or more surfaces by pendulum, rollers, ball bearings, sliders, and other support mechanism which allows free movement of bob 18 within housing 13 in the presence of vibration induced by machine tool 11 and further provides a restoring feature to bring bob 18 back to a neutral position during the absence of vibration from machine tool 11.

Mass damper 12 operates to conserve kinetic energy. The vibration of machine tool 11 causes motion in bob 18. The restoring forces of compression springs 36 and 38 and bearings 26 operate to bring bob 18 back to rest in its neutral position. If mass damper 12 is properly tuned, i.e. the vibrating center frequency of machine tool 11 falls within the bandwidth of the frequency response of mass damper 12, then bob 18 oscillates in opposite phase with the vibration induced by machine tool 11 thereby counteracting, suppressing, reducing, canceling, and/or neutralizing the undesired vibration. The geometry and mass of bob 18 and the spring constants of springs 36 and 38 and the compression on springs 36 and 38 will define the natural resonant center frequency of mass damper 12. Accordingly, the natural resonant center frequency of mass damper 12 can be changed by altering or adjusting one or more of these physical characteristics.

The restoration forces can also be controlled in other embodiments of the support mechanism for bob 18. For example, the restoring force of a pendulum swing can be altered or changed by control of the coefficients of kinetic and static friction at the fulcrum. The restoring force of rollers and ball bearings can be altered or changed by control of the coefficients of kinetic and static friction on their 4 contact surfaces.

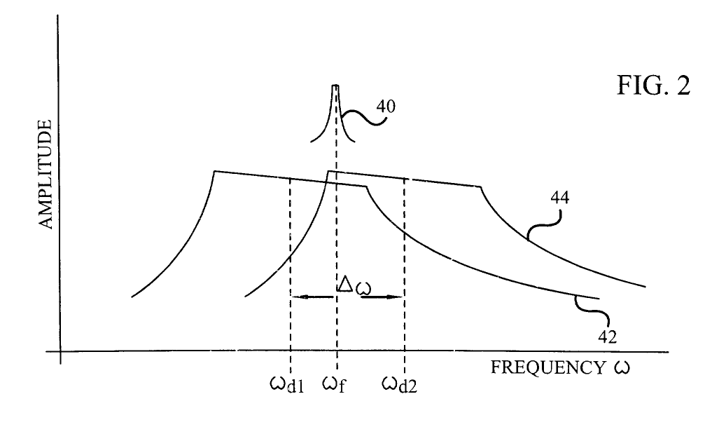

FIG. 2 illustrates frequency response plots of amplitude versus frequency for machine tool 11 and mass damper 12. Plot 40 represents the frequency response of machine tool 11. Machine tool 11 operating with a particular configuration exhibits a relatively narrow frequency response centered about frequency ω_{f}. Plot 40 may have a wider frequency response depending on the operating point(s) of machine tool 11. Plot 42 represents the frequency response of mass damper 12. Mass damper 12 configured as described in FIG. 1 will have a broad bandwidth frequency response centered about frequency ω_{d1}. As shown, the center frequency Of falls within the bandwidth centered about frequency ω_{d1}. Mass damper 12 will provide the desired vibration dampening function so long as the frequency response of machine tool 11 falls within the bandwidth of the frequency response of mass damper 12.

If the configuration or operating parameters of machine tool 11 change such that the center frequency ω_{f} shifts outside the bandwidth of mass damper 12, then mass damper 12 will no longer provide the desired vibration dampening function. Assume that the center frequency ω_{f} shifts up in frequency by Δω, for example, by changing the CMP process which is running on machine tool 11. Further assume that mass damper 12 changes or alters its center frequency by Δω. The new center frequency of mass damper 12 is ω_{d2}. The change in center frequency to ω_{d2} is shown as plot 44 in FIG. 2. Plot 44 is higher in frequency as compared to plot 42 so that the frequency response of machine tool 11, with its new configuration, falls with the new bandwidth of mass damper 12 now centered at frequency ω_{d2}. Mass damper 12 will again provide the desired vibration dampening function.

Since the change in frequency by Δω is not negligible as compared to the bandwidth of plot 42 or plot 44, the illustrated phase shifting is generally not a sensitive process. Accordingly, mass damper 12 is suitably robust at center frequency ω_{d1} and center frequency ω_{d2}. There may be some difference in shape of plot 42 versus the shape of plot 44, but any difference should not effect the principal operation and function of mass damper 12.

To achieve the change in center frequency of mass damper 12, mass damper system 10 includes a sensor or detector 50 attached or secured to machine tool 11 by screws 52 or other suitable attachment mechanism to sense or detect changes in vibration frequency. Sensor 50 provides a sensor signal to controller 54 which in turn provides a control signal to actuator 56. Sensor 50 is an accelerometer measuring acceleration. Controller 54 integrates the sensor signal once for velocity and twice for displacement. Actuator 56 is attached or secured to housing 13 with screw 58 or other suitable rigid attachment mechanism. Actuator 56 includes an electric motor driving a ball-screw shaft and piston assembly 60 which extends through opening 62 in housing 13. Piston assembly 60 connects to compression spring 38 and acts to increase or decrease compression on the spring. An actuator like 56 and piston assembly like 60 is provided for each compression spring 38.

If machine tool 11 changes in operation or configuration such that its vibration center frequency increases by Δω, then sensor 50 senses the change in vibration frequency and provides a sensor signal to controller 54. Controller 54 converts the sensor signal to a control signal for actuator 56 which causes piston assembly 60 to travel to the left in FIG. 1, further into housing 13, thereby increasing the compression on spring 38. The additional compression on spring 38 increases the restoring force to bob 18 and effectively increases the center frequency of mass damper 12 by the same frequency Δω, or other appropriate frequency, so that the new frequency response of machine tool 11 falls within the new bandwidth of mass damper 12. In other words, the frequency response of mass damper 12 shifts from plot 42 to plot 44 as shown in FIG. 2 so that mass damper 12 will provide the necessary vibration dampening function for machine tool 11.

If machine tool 11 changes in operation or configuration such that its vibration center frequency decreases by Δω, then sensor 50 senses the change in vibration frequency and provides another sensor signal to controller 54. Controller 54 converts the sensor signal to a control signal for actuator 56 which causes piston assembly 60 to travel to the right in FIG. 1, less into housing 13, thereby decreasing the compression on spring 38. The reduced compression on spring 38 decreases the restoring force to bob 18 and effectively decreases the center frequency of mass damper 12 by the same frequency Δω, or other appropriate frequency, so that the new frequency response of machine tool 11 falls within the bandwidth of mass damper 12. The frequency response of mass damper 12 shifts from plot 44 to plot 42 as shown in FIG. 2 so that mass damper 12 will provide the necessary vibration dampening function for machine tool 11.

The force applying mechanism to increase and decrease compression on spring 38 is shown in FIG. 1 as an actuator with a ball screw driven piston assembly applying a mechanical force. In alternative embodiment, the force applying mechanism could be electromagnetic in nature which provides a faster response than the mechanical force but typically with less magnitude than the mechanical force. Other force applying mechanisms could be derived from capacitive and piezoelectric elements. Again, even faster in response than the electromechanical force but with correspondingly with less magnitude. The force applying mechanisms are applicable to the alternative force restoring and support mechanisms described in paragraph 17 above.

Sensor 50 may sense or detect any physical action or characteristic, such as acceleration, velocity, or displacement, and provide a sensor signal to controller 54. Controller 54 converts the physical action to a control signal to drive actuator 56 and piston assembly 60 or other force applying mechanisms as described above.

Another feature of mass damper 12 is shown in FIG. 1 as transducer 70. Transducer 70 is used in place of sensor 50. Transducer 70 is attached or secured to housing 13 by screws 72, or other suitable attachment mechanism. Transducer 70 includes a needle tip 74 with spring loading or other 30 pressure mechanism so as to remain in continuous contact with bob 18 during its motion. Transducer 70 thus senses the motion of bob 18 relative to housing 13 and provides a transducer signal to controller 54. Controller 54 utilizes the transducer signal instead of the sensor signal to control actuator 56. Transducer 70 can be a velocity meter, e.g. tachometer or linear velocity transducer. Alternatively, transducer 70 is a direct displacement transducer or position meter. Controller 54 integrates or takes the derivation of the transducer signal to control actuator 56 as described above.

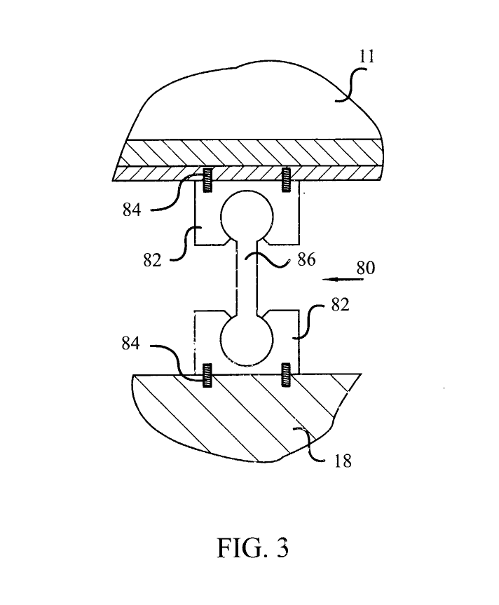

FIG. 3 illustrates support assembly 80 as an alternative for spring 36 to provide a gravity restoring force. Support assembly 80 comprises two end hinges 82 attached or secured with screws 84, or other suitable attachment mechanism, to the bottom base or plate of machine tool 11 and to a top surface of bob 18. Rod 86 includes ball-shaped ends that fit into sockets of end hinges 82. Support assembly 80 provides a gravity restoring force for mass damper 12.

In summary, a mass damper includes a sensor or transducer that senses changes in vibration frequency or other physical action and controls an actuator to move a piston assembly. The piston assembly operates to increase or decrease compression on a spring attached to a bob or moveable mass within the housing of the mass damper. The change in compression on the restoring spring effectively changes the center frequency of mass damper 12 so that any change in the frequency response of the machine tool still falls within the bandwidth of the mass damper.

Although the present invention has been described with respect to preferred embodiments, any person skilled in the art will recognize that changes may be made in form and detail, and equivalents may be substituted for elements of the invention without departing from the spirit and scope of the invention. Therefore, it is intended that the invention not be limited to the particular embodiments disclosed for carrying out this invention, but will include all embodiments falling within the scope of the appended claims.

What is claimed is:

1. A mass damper for suppressing a source of vibration, comprising:
a housing adapted for coupling to the source of vibration;
a mass within the housing;
a first spring having a first end coupled to a surface of the mass; and
an actuator coupled to a second end of the first spring for altering compression on the first spring.

2. The mass damper of claim 1, wherein altering compression of the first spring changes a resonant center frequency of the mass damper.

3. The mass damper of claim 1, further including a controller coupled for receiving a sense signal representative of the source of vibration and providing a control signal to the actuator.

4. The mass damper of claim 1, wherein the actuator includes a piston assembly coupled to the first spring and moveable to alter the compression of the first spring.

5. The mass damper of claim 1, wherein the mass is attached to the housing at a plurality of contact points.

6. The mass damper of claim 1, further including a second spring coupled between an upper surface of the mass and the housing.

7. The mass damper of claim 1, further including:
a first hinge coupled to an upper surface of the mass and having a socket;
a second hinge coupled to the housing and having a socket; and
a rod having a first ball-shaped end for mating with the socket of the first hinge and a second ball-shaped end for mating with the socket of the second hinge.

8. The mass damper of claim 1, further including:
a transducer having an arm continuously in contact with the mass and providing a transducer signal; and
a controller coupled for receiving the transducer signal and providing a control signal to the actuator.

9. A mass damper, comprising:
a housing adapted for receiving a vibration;
a mass within the housing;
a restoring force mechanism coupled to the mass; and
a force applying mechanism coupled to the restoring force mechanism for altering a center frequency of the mass damper.

10. The mass damper of claim 9, wherein the restoring force mechanism includes a spring coupled between the mass and the force applying mechanism.

11. The mass damper of claim 10, wherein the force applying mechanism includes an actuator operating in response to a control signal and coupled to one end of the spring for altering compression on the spring which changes the center frequency of the mass damper.

12. The mass damper of claim 11, further including a controller coupled for receiving a sense signal representative of the vibration and providing the control signal to the actuator.

13. The mass damper of claim 12, wherein the actuator includes a piston assembly coupled to the spring and moveable to alter compression of the spring.

14. The mass damper of claim 9, wherein the mass is attached to the housing at a plurality of contact points.

15. The mass damper of claim 9, wherein the restoring force mechanism includes one of a group of mechanical, electromechanical, capacitive, and piezoelectric.

16. A method of dampening a vibration, comprising:
providing a mass within a housing;
providing a spring having a first end coupled to a surface of the mass; and
applying a force to a second end of the spring to alter compression on the spring and change a center frequency of the dampening.

17. The method of claim 16, further including sensing a physical characteristic of the vibration and generating a control signal in response thereto.

18. The method of claim 17, further including activating an actuator operating in response to the control signal to move a piston assembly coupled to the second end of the spring.

19. The method of claim 16, wherein the mass is attached to the housing at a plurality of contact points.

20. A method of suppressing a vibration, comprising:
providing a housing adapted for receiving the vibration;
providing a mass within the housing such that the mass moves in response to the vibration;
providing a restoring force mechanism coupled to the mass and acting to return the mass to a neutral position; and
applying a force to the restoring force mechanism to alter a center frequency of the suppression of the vibration.

21. The method of claim 20, wherein the restoring force mechanism includes a spring having a first end coupled to the mass and a second end coupled for receiving the force.

22. The method of claim 21, further including sensing a physical characteristic of the vibration and generating a control signal in response thereto.

23. The method of claim 22, wherein the step of applying a force includes activating an actuator operating in response to the control signal and coupled to the second end of the spring for altering compression on the spring.
